(19) United States
(12) Patent Application Publication
(10) Pub. No.: US 2016/0274581 A1
(43) Pub. Date: Sep. 22, 2016

(54) COMPLEX PARENT-SUBSIDIARY MOBILE CARRIER

(71) Applicant: CHEN-HSIN LIN, NEW TAIPEI CITY (TW)

(72) Inventor: CHEN-HSIN LIN, NEW TAIPEI CITY (TW)

(21) Appl. No.: 15/059,613

(22) Filed: Mar. 3, 2016

(30) Foreign Application Priority Data
Mar. 9, 2015 (TW) 104203428

(51) Int. Cl. G05D 1/00; H04W 4/02; B64C 37/02; B63B 7/04; B62D 53/00; H04W 4/00; G05D 1/02

(52) U.S. Cl. CPC G05D 1/0027; H04W 4/005; H04W 4/02; G05D 1/0022; G05D 1/0202; G05D 1/0206; G05D 1/021; G05D 1/0289; B63B 7/04; B62D 53/005; B64C 37/02; B63B 2007/006

(57) ABSTRACT

A complex parent-subsidiary mobile carrier, which is manned or unmanned and remotely controllable. The complex carrier can operate in a combined mode and a separated mode. The complex carrier includes a parent carrier having a first connection section and a subsidiary carrier having a second connection section releasably mated and connected with the first connection section. At least one of the parent carrier and the subsidiary carrier has self-moving ability. The complex carrier includes a power control unit capable of controlling the moving speed and direction of the complex carrier. A remote control unit is disposed between the parent carrier and the subsidiary carrier for transmitting remote control signals to control the power control unit. The parent carrier and the subsidiary carrier can be integrally combined to move together. Alternatively, the parent carrier and the subsidiary carrier can be separated to respectively move.

### BACKGROUND OF THE INVENTION

1. Field of the Invention

The present invention relates generally to a transportation tool, and more particularly to a complex parent-subsidiary mobile carrier. The complex parent-subsidiary mobile carrier can be manned or unmanned and remotely controlled. The complex parent-subsidiary mobile carrier includes a parent carrier and at least one subsidiary carrier. The parent carrier and the subsidiary carrier can be integrally combined to move together. Alternatively, the parent carrier and the subsidiary carrier can be separated to respectively back and forth move by means of remote control or dragging.

2. Description of the Related Art

It is known that the current transportation tools including water mobiles (such as ships and boats), land mobiles (such as vehicles) and aircrafts (such as airplanes) are mainly used to carry persons and transfer cargoes. In order to make the transportation tools multiuse, a technique that a small-scale transportation tool is carried in a large-scale transportation tool has been developed. For example, a vehicle, an airplane or a small-size boat is carried on a ship. In use, a driver can drive the vehicle, the airplane or the small-size boat to separate from the ship. After the vehicle, the airplane or the small-size boat is separated from the ship, they can independently run. Moreover, after separated from the ship, the vehicle, the airplane or the small-size boat can be used to achieve other usage independent from the ship. However, such technique can be hardly further advanced. This needs to be overcome.

### SUMMARY OF THE INVENTION

It is therefore a primary object of the present invention to provide a complex parent-subsidiary mobile carrier. The complex parent-subsidiary mobile carrier can be manned or unmanned and remotely controlled. The complex parent-subsidiary mobile carrier includes a parent carrier and at least one subsidiary carrier. The parent carrier and the subsidiary carrier can be integrally combined to move together. Alternatively, the parent carrier and the subsidiary carrier can be separated to respectively back and forth move by means of remote control or dragging. Accordingly, the transportation tool can be used in a combined mode and a separated mode. Therefore, the parent carrier and the subsidiary carrier can respectively run and back and forth run by dragging and remote control. Under such circumstance, the use of the transportation tool is diversified to widen the application range of the transportation tool and enhance the convenience and utility thereof in use.

To achieve the above and other objects, the complex parent-subsidiary mobile carrier of the present invention includes: a parent carrier having self-moving ability, the parent carrier including a first connection section disposed on the parent carrier; and at least one subsidiary carrier including a second connection section disposed on the subsidiary carrier and releasably mated and connected with the first connection section, whereby the first and second connection sections can be mated and connected with each other to combine the parent carrier and the subsidiary carrier into the complex carrier.

In the above complex parent-subsidiary mobile carrier, the first connection section of the parent carrier can be mated and connected with the second connection section of the subsidiary carrier to assemble the parent carrier and the subsidiary carrier with each other to form one single mobile complex transportation tool. In use, according to requirements, the first connection section of the parent carrier can be separated from the second connection section of the subsidiary carrier. Under such circumstance, the parent carrier and the subsidiary carrier can be separated from each other to respectively move.

The complex carrier further includes a power control unit capable of controlling the moving speed and direction of at least one of the parent carrier and the subsidiary carrier. The complex carrier further includes a remote control unit for transmitting/receiving remote control signals to remotely control the power control unit. The power control unit has a main power control unit disposed on the parent carrier for controlling the moving speed and direction of the parent carrier. The remote control unit is disposed on the subsidiary carrier for transmitting/receiving remote control signals to remotely control the main power control unit. Accordingly, in the condition that the parent carrier and the subsidiary carrier are connected with each other, a driver can sit on the subsidiary carrier and use the remote control unit on the subsidiary carrier to remotely control the main power control unit of the parent carrier. In this case, the subsidiary carrier can be driven by the parent carrier to move together with the parent carrier. In addition, in the condition that the subsidiary carrier is separated from the parent carrier, the subsidiary carrier can solely run and move. Alternatively, the remote control unit on the subsidiary carrier can be used to remotely control the main power control unit to drive the parent carrier to run and move. Under such circumstance, the subsidiary carrier can move along with the parent carrier. Accordingly, the complex parent-subsidiary mobile carrier can be manned or unmanned and remotely controlled and the parent carrier and the subsidiary carrier can be integrally combined to move together or the parent carrier and the subsidiary carrier can be separated to respectively back and forth move by means of remote control.

Alternatively, the power control unit has a subsidiary power control unit disposed on the subsidiary carrier for controlling the moving speed and direction of the subsidiary carrier. The remote control unit is disposed on the parent carrier for transmitting/receiving remote control signals to remotely control the subsidiary power control unit.

In the above complex parent-subsidiary mobile carrier, the power control unit and the remote control unit are respectively electrically connected to signal transmitting/receiving units. The signal transmitting/receiving units serve to transmit the remote control signals by means of at least one of wired, wireless and GPS navigation systems.

In the above complex parent-subsidiary mobile carrier, the parent carrier is connected to the subsidiary carrier via a dragging member for dragging the subsidiary carrier. Accordingly, in the condition that the subsidiary carrier is separated from the parent carrier, the subsidiary carrier can be dragged by the parent carrier to move along with the parent carrier.

The complex carrier is selected from a group consisting of water mobile, land mobile and aircraft. The water mobiles can be ships, speedboats, inflatable rubber boats, hovercraft, etc. The land mobiles can be automobiles, motorbikes, trains, trams, tractors, tanks, etc. The aircrafts can be airplanes, helicopters, airships, hot-air balloons, etc.

The present invention can be best understood through the following description and accompanying drawings, wherein:

### BRIEF DESCRIPTION OF THE DRAWINGS

FIG. 1 is a top view of a first embodiment of the present invention;

FIG. 2 is a top view of the first embodiment of the present invention according to FIG. 1, showing a using state thereof;

FIG. 3 is a block diagram of the present invention, showing the function thereof;

FIG. 4 is a top view of the first embodiment of the present invention according to FIG. 1, showing another using state thereof;

FIG. 5 is a top view of the first embodiment of the present invention according to FIG. 1 in another aspect;

FIG. 6 is a top view according to FIG. 5, showing the using state thereof;

FIG. 7 is a side view of the first embodiment of the present invention according to FIG. 1 in still another aspect;

FIG. 8 is a side view of a second embodiment of the present invention;

FIG. 9 is a side view of the second embodiment of the present invention according to FIG. 8, showing the using state thereof;

FIG. 10 is a top view of a third embodiment of the present invention;

FIG. 11 is a top view of the third embodiment of the present invention according to FIG. 10, showing a using state thereof; and

FIG. 12 is a top view of the third embodiment of the present invention according to FIG. 10, showing another using state thereof.

### DETAILED DESCRIPTION OF THE PREFERRED EMBODIMENTS

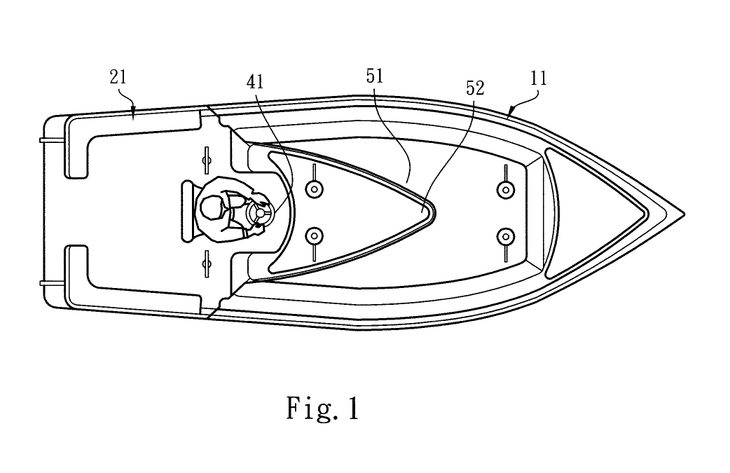

Please refer to FIGS. 1 to 3. According to a first embodiment, the complex parent-subsidiary mobile carrier of the present invention includes a parent carrier 11 and at least one subsidiary carrier 21. The parent carrier 11 and the subsidiary carrier 21 can be both water mobiles, land mobiles or aircrafts. The water mobiles can be ships, speedboats, inflatable rubber boats, hovercraft, submarines, etc. The land mobiles can be automobiles, motorbikes, trains, trams, tractors, tanks, etc. The aircrafts can be airplanes, helicopters, airships, hot-air balloons, etc.

In this embodiment, the parent carrier 11 and the subsidiary carrier 21 are both speedboats. The parent carrier 11 is self-movable. The parent carrier 11 includes a first connection section 51 disposed on the parent carrier 11. The subsidiary carrier 21 includes a second connection section 52 disposed on the subsidiary carrier 21 and releasably mated and connected with the first connection section 51. Accordingly, the first and second connection sections 51, 52 can be mated and connected with each other to combine the parent carrier 11 and the subsidiary carrier 21 into a complete complex carrier. The complex carrier includes a power control unit capable of controlling the moving speed and direction of the parent carrier 11 and/or the subsidiary carrier 21. In addition, the complex carrier includes a remote control unit 41 for transmitting/receiving remote control signals to remotely control the power control unit. The power control unit and the remote control unit 41 are respectively electrically connected to signal transmitting/receiving units 32, 42.

In a preferred embodiment, the power control unit has a main power control unit 33 disposed on the parent carrier 11 for controlling the moving speed and direction of the parent carrier 11. The main power control unit 33 is electrically connected to the signal transmitting/receiving unit 32. The first connection section 51 is disposed at rear end of the parent carrier 11. The remote control unit 41 is disposed on the subsidiary carrier 21 for transmitting/receiving remote control signals to remotely control the main power control unit 33. The remote control unit 41 is electrically connected to the signal transmitting/receiving unit 42. The second connection section 52 is disposed at front end of the subsidiary carrier 21.

As shown in FIG. 1, the first connection section 51 of the parent carrier 11 can be mated and connected with the second connection section 52 of the subsidiary carrier 21 to assemble the parent carrier 11 and the subsidiary carrier 21 with each other to form one single mobile transportation tool. Accordingly, in the condition that the parent carrier 11 and the subsidiary carrier 21 are connected with each other, a driver can sit on the subsidiary carrier 21 and use the remote control unit 41 on the subsidiary carrier 21 to remotely control the main power control unit 33 of the parent carrier 11. In this case, by means of the self-moving ability of the main power control unit 33 of the parent carrier 11, the subsidiary carrier 21 can be driven to run together with the parent carrier 11.

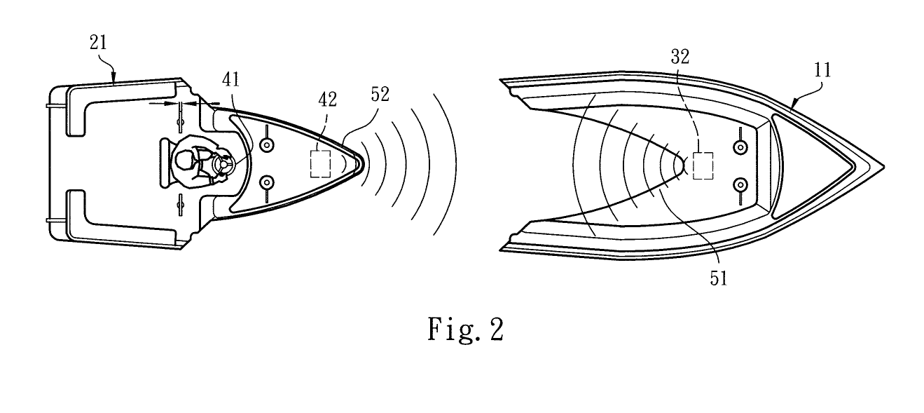

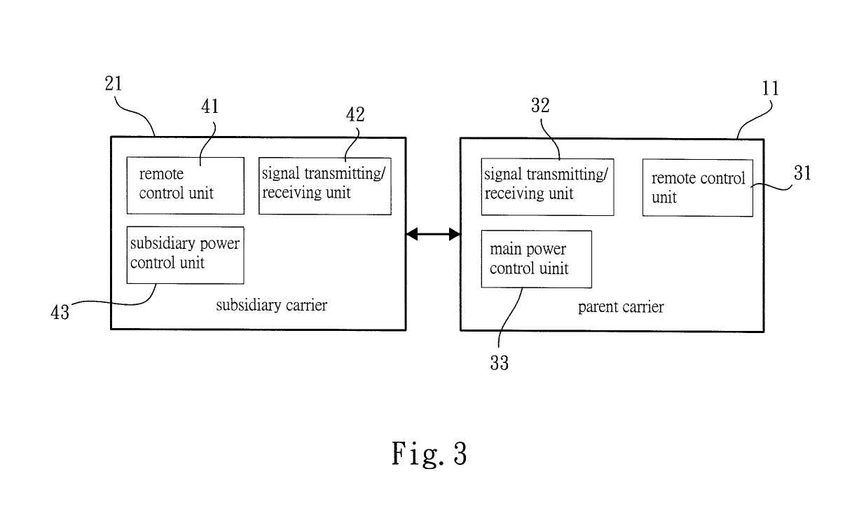

As shown in FIGS. 2 and 3, in use, according to requirements, the first connection section 51 of the parent carrier 11 can be separated from the second connection section 52 of the subsidiary carrier 21. Under such circumstance, the parent carrier 11 and the subsidiary carrier 21 can be separated from each other to independently move. In addition, with the parent carrier 11 and the subsidiary carrier 21 separated from each other, a driver can respectively control the parent carrier 11 or the subsidiary carrier 21 to self-move. Alternatively, by means of controlling the remote control unit 41 on the subsidiary carrier 21, the signal transmitting/receiving unit 42 can emit a remote control signal wirelessly or via GPS navigation system, whereby the main power control unit 33 on the parent carrier 11 can receive the remote control signal via the signal transmitting/receiving unit 32 so as to remotely control the main power control unit 33 to control the parent carrier 11 to solely run and move.

In another embodiment, the power control unit has a subsidiary power control unit 43 disposed on the subsidiary carrier 21 for controlling the moving speed and direction of the subsidiary carrier 21 (as shown in FIG. 3). Accordingly, the subsidiary carrier 21 is self-movable. The remote control unit 31 is disposed on the parent carrier 11 for transmitting/receiving remote control signals to remotely control the subsidiary power control unit 43. In this case, the parent carrier 11 can remotely control the move of the subsidiary carrier 21. In addition, the subsidiary carrier 21 can be separated from the parent carrier 11 to solely run and move. Also, in the condition that the parent carrier 11 is remotely controlled, the subsidiary carrier 21 can follow the parent carrier 11 to move by its own power.

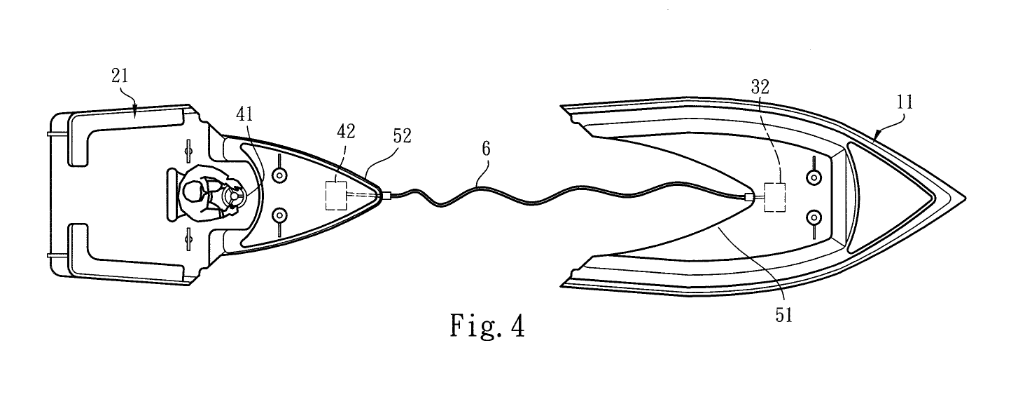

Please now refer to FIG. 4. In a modified embodiment, the parent carrier 11 is connected to the subsidiary carrier 21 via a dragging member 6 for dragging the subsidiary carrier 21. The dragging member 6 can be a cable. In addition, the signal transmitting/receiving unit 42 of the subsidiary carrier 21 and the signal transmitting/receiving unit 32 of the parent carrier 11 can be connected with each other by an electrical wire coaxial with the dragging member 6. In this case, the signal transmitting/receiving unit 42 of the subsidiary carrier 21 can transmit the remote control signals to the signal transmitting/receiving unit 32 of the parent carrier 11 in a wired manner. Accordingly, in the condition that the subsidiary carrier 21 is separated from the parent carrier 11, the subsidiary carrier 21 can be dragged by the parent carrier 11 to move along with the parent carrier 11.

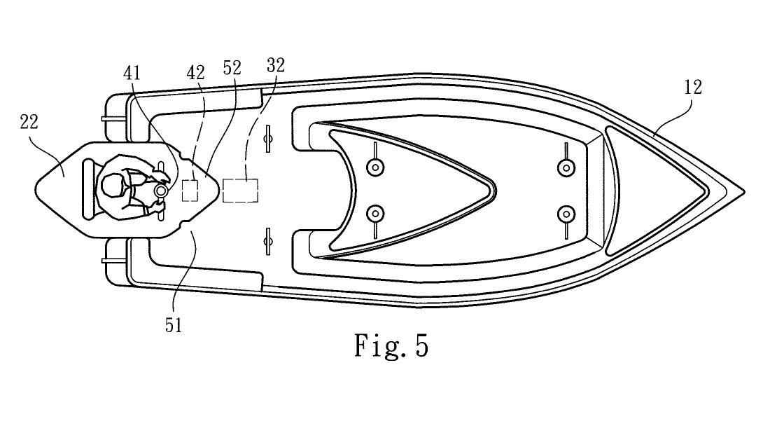

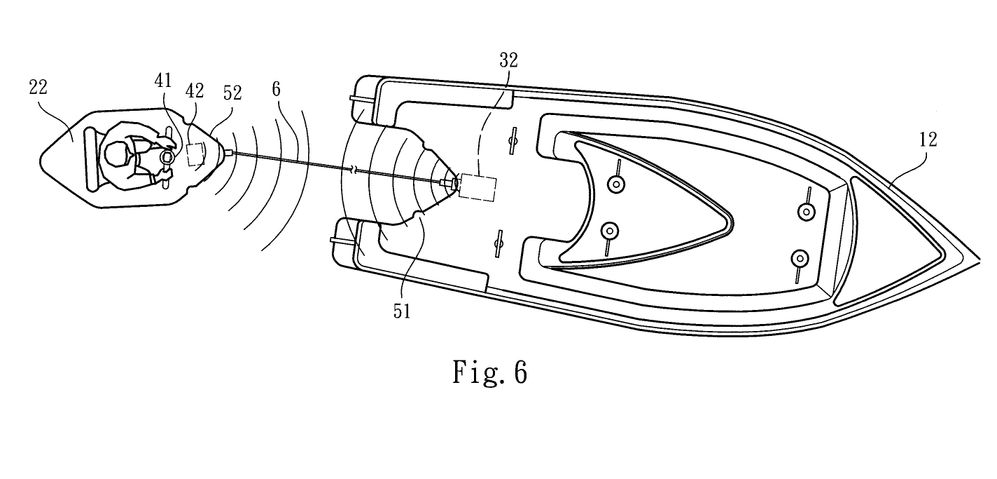

Please refer to FIGS. 5 and 6. In another embodiment, the parent carrier 12 is a speedboat, while the subsidiary carrier 22 is a jet ski. The parent carrier 12 and the subsidiary carrier 22 can be connected by the dragging member 6 or not. Accordingly, the parent carrier 12 and the subsidiary carrier 22 can be combined into a special and novel water-borne transportation tool. In the case that the parent carrier 12 is a speedboat, the subsidiary carrier can be an inflatable rubber boat, a glider, a drag parachute or a hot-air balloon.

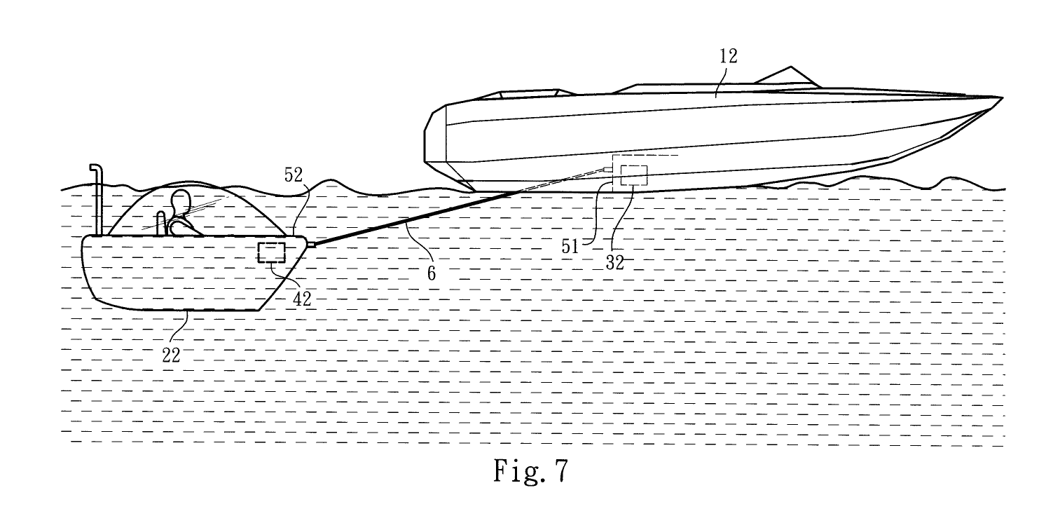

Please refer to FIG. 7. In still another embodiment, the parent carrier 12 is a speedboat, while the subsidiary carrier 22 is a submarine. The submarine can be a semi-skin-diving powerless submarine. The top of the submarine has a transparent cockpit. A dragging member 6 is connected between the parent carrier 12 and the subsidiary carrier 22 to form another special and novel water-borne transportation tool. Accordingly, with the subsidiary carrier 22 separated from the parent carrier 12, a user can take the subsidiary carrier 22. At this time, the signal transmitting/receiving unit 42 of the subsidiary carrier 22 can transmit the remote control signals to the signal transmitting/receiving unit 32 of the parent carrier 12 in a wired or wireless manner or via GPS navigation so as to control the parent carrier 12 to drag the subsidiary carrier 22 to run in a semi-skin-diving or full-diving manner.

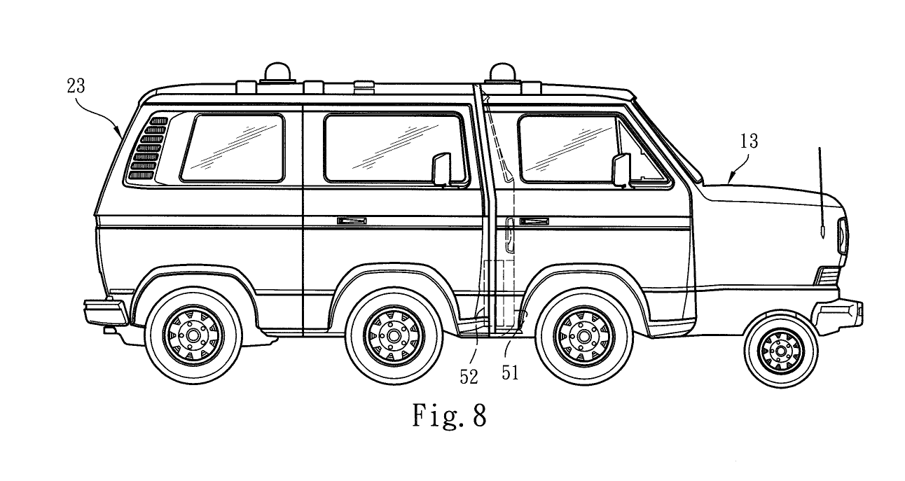

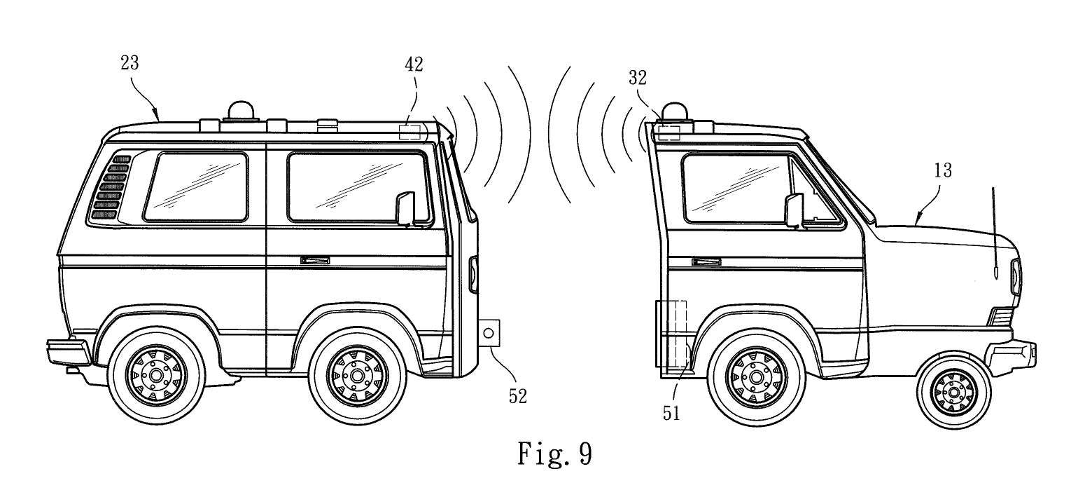

Please now refer to FIGS. 8 and 9, which show a second embodiment of the present invention. In the second embodiment, the parent carrier 13 and the subsidiary carrier 23 are both automobiles. The subsidiary carrier 23 can be self-movable or not self-movable. The parent carrier 13 and the subsidiary carrier 23 are assembled to form a special and novel vehicle. The first and second connection sections 51, 52 can be connected to assemble the parent carrier 13 and the subsidiary carrier 23 into one single vehicle. In this case, a driver can optionally sit on the parent carrier 13 to drive the vehicle. In the condition that the parent carrier 13 is separated from the front end of the subsidiary carrier 23, the driver can optically sit on the subsidiary carrier 23. At this time, the driver can use the signal transmitting/receiving unit 42 on the subsidiary carrier 23 to wirelessly transmit the remote control signals to the signal transmitting/receiving unit 32 on the parent carrier 13 so as to wirelessly remotely control the parent carrier 13 to solely run and move.

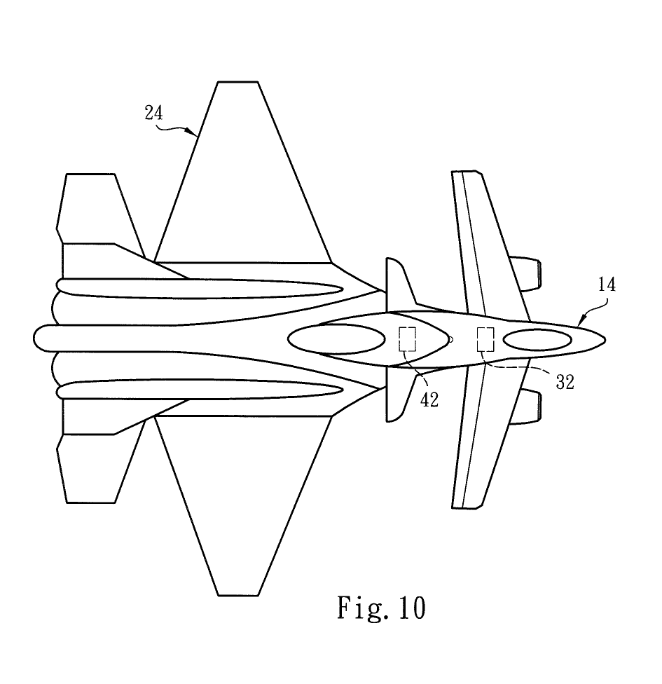

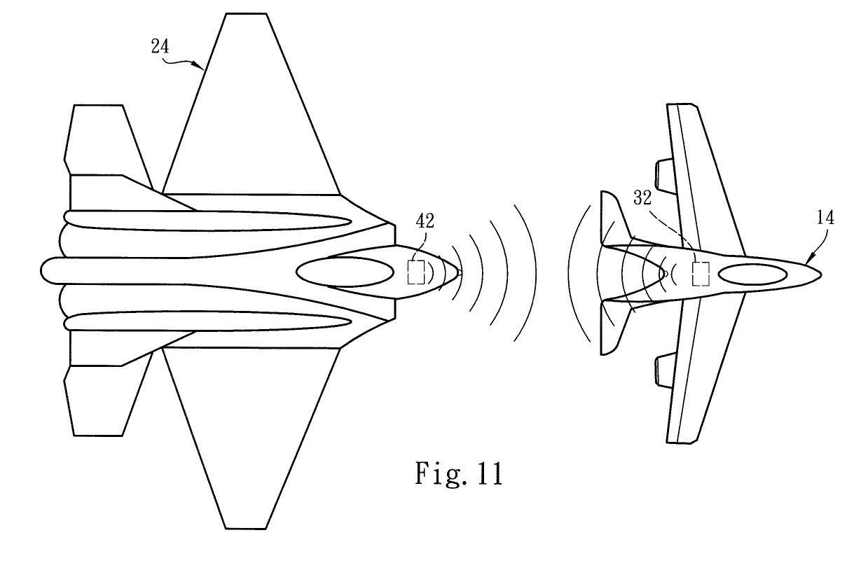

Please now refer to FIGS. 10 and 11, which show a third embodiment of the present invention. In the third embodiment, the parent carrier 14 and the subsidiary carrier 24 are both airplanes. Alternatively, the subsidiary carrier 24 is glider without self-moving ability. The parent carrier 14 and the subsidiary carrier 24 can be back and forth mated and connected with each other to form a special and novel aircraft. When the parent carrier 14 and the subsidiary carrier 24 are assembled into one single aircraft, the parent carrier 14 and the subsidiary carrier 24 can fly together. In the condition that the parent carrier 14 is separated from the subsidiary carrier 24, a driver can sit in the subsidiary carrier 24 and use the signal transmitting/receiving unit 42 on the subsidiary carrier 24 to wirelessly transmit the remote control signals to the signal transmitting/receiving unit 32 on the parent carrier 14 so as to wirelessly remotely control the parent carrier 14 to fly.

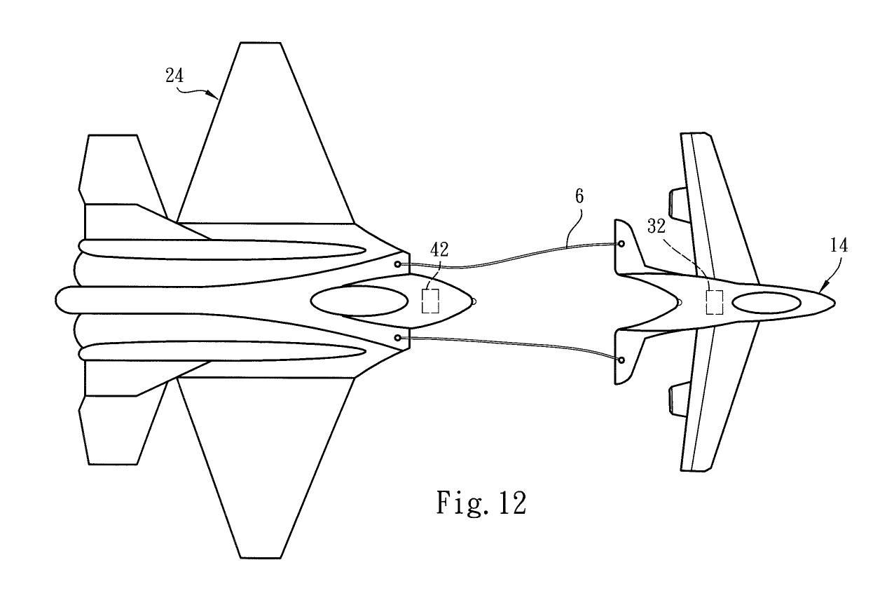

Please now refer to FIG. 12. In a modified embodiment, the parent carrier 14 can drag the subsidiary carrier 24 via at least one dragging member 6. In this embodiment, the dragging members 6 can be two cables. The two dragging members 6 are respectively connected to two sides of the airplane body of the parent carrier 14 and two sides of the airplane body of the subsidiary carrier 24. The signal transmitting/receiving unit 42 of the subsidiary carrier 24 and the signal transmitting/receiving unit 32 of the parent carrier 14 are also connected with each other via an electrical wire coaxial with the dragging member 6. Accordingly, the signal transmitting/receiving unit 42 of the subsidiary carrier 24 can transmit the remote control signals to the signal transmitting/receiving unit 32 of the parent carrier 14 in a wired manner. Therefore, in the condition that the subsidiary carrier 24 is separated from the parent carrier 14, the subsidiary carrier 24 can be dragged by the parent carrier 14 to move along with the parent carrier 14. It should be noted that during the flight, when it is necessary to back and forth mate and connect the parent carrier 14 with the subsidiary carrier 24, the two dragging members 6 connected to two sides of the airplane body of the parent carrier 14 and two sides of the airplane body of the subsidiary carrier 24 can provide two-point locating effect. The dragging members 6 can be synchronously wound up to shorten the distance between the parent carrier 14 and the subsidiary carrier 24. Moreover, the dragging members 6 can together guide and correct the relative positions of two sides of the parent carrier 14 and the subsidiary carrier 24. Accordingly, during the flight, the parent carrier 14 and the subsidiary carrier 24 can be precisely back and forth mated and connected with each other.

According to the above arrangement, the transportation tool can be used in a combined mode and a separated mode. Therefore, the parent carrier and the subsidiary carrier can respectively run and back and forth run by dragging and remote control. In this case, the parent carrier and the subsidiary carrier can be combined or separated to carry a user and run together or run back and forth by remote control. Under such circumstance, the use of the transportation tool is diversified to widen the application range of the transportation tool and enhance the convenience and utility thereof in use.

The above embodiments are only used to illustrate the present invention, not intended to limit the scope thereof. Many modifications of the above embodiments can be made without departing from the spirit of the present invention.

What is claimed is:

1. A complex parent-subsidiary mobile carrier comprising:
a parent carrier having self-moving ability, the parent carrier including a first connection section disposed on the parent carrier; and
at least one subsidiary carrier including a second connection section disposed on the subsidiary carrier and releasably mated and connected with the first connection section, whereby the first and second connection sections can be mated and connected with each other to combine the parent carrier and the subsidiary carrier into the complex carrier.

2. The complex parent-subsidiary mobile carrier as claimed in claim 1, wherein the complex carrier includes a power control unit capable of controlling the moving speed and direction of at least one of the parent carrier and the subsidiary carrier, the complex carrier further including a remote control unit for transmitting/receiving remote control signals to remotely control the power control unit.

3. The complex parent-subsidiary mobile carrier as claimed in claim 2, wherein the power control unit has a main power control unit disposed on the parent carrier for controlling the moving speed and direction of the parent carrier, the remote control unit being disposed on the subsidiary carrier for transmitting/receiving remote control signals to remotely control the main power control unit.

4. The complex parent-subsidiary mobile carrier as claimed in claim 2, wherein the power control unit has a subsidiary power control unit disposed on the subsidiary carrier for controlling the moving speed and direction of the subsidiary carrier, the remote control unit being disposed on the parent carrier for transmitting/receiving remote control signals to remotely control the subsidiary power control unit.

5. The complex parent-subsidiary mobile carrier as claimed in claim 2, wherein the power control unit and the remote control unit are respectively electrically connected to signal transmitting/receiving units.

6. The complex parent-subsidiary mobile carrier as claimed in claim 3, wherein the power control unit and the remote control unit are respectively electrically connected to signal transmitting/receiving units.

7. The complex parent-subsidiary mobile carrier as claimed in claim 4, wherein the power control unit and the remote control unit are respectively electrically connected to signal transmitting/receiving units.

8. The complex parent-subsidiary mobile carrier as claimed in claim 5, wherein the signal transmitting/receiving units serve to transmit/receive the remote control signals by means of at least one of wired, wireless and GPS navigation systems.

9. The complex parent-subsidiary mobile carrier as claimed in claim 1, wherein the parent carrier is connected to the subsidiary carrier via a dragging member for dragging the subsidiary carrier.

10. The complex parent-subsidiary mobile carrier as claimed in claim 2, wherein the parent carrier is connected to the subsidiary carrier via a dragging member for dragging the subsidiary carrier.

11. The complex parent-subsidiary mobile carrier as claimed in claim 3, wherein the parent carrier is connected to the subsidiary carrier via a dragging member for dragging the subsidiary carrier.

12. The complex parent-subsidiary mobile carrier as claimed in claim 4, wherein the parent carrier is connected to the subsidiary carrier via a dragging member for dragging the subsidiary carrier.

13. The complex parent-subsidiary mobile carrier as claimed in claim 5, wherein the parent carrier is connected to the subsidiary carrier via a dragging member for dragging the subsidiary carrier.

14. The complex parent-subsidiary mobile carrier as claimed in claim 8, wherein the parent carrier is connected to the subsidiary carrier via a dragging member for dragging the subsidiary carrier.

15. The complex parent-subsidiary mobile carrier as claimed in claim 1, wherein the complex carrier is selected from a group consisting of water mobile, land mobile and aircraft.

16. The complex parent-subsidiary mobile carrier as claimed in claim 2, wherein the complex carrier is selected from a group consisting of water mobile, land mobile and aircraft.

17. The complex parent-subsidiary mobile carrier as claimed in claim 3, wherein the complex carrier is selected from a group consisting of water mobile, land mobile and aircraft.

18. The complex parent-subsidiary mobile carrier as claimed in claim 4, wherein the complex carrier is selected from a group consisting of water mobile, land mobile and aircraft.

19. The complex parent-subsidiary mobile carrier as claimed in claim 5, wherein the complex carrier is selected from a group consisting of water mobile, land mobile and aircraft.

20. The complex parent-subsidiary mobile carrier as claimed in claim 9, wherein the complex carrier is selected from a group consisting of water mobile, land mobile and aircraft.
